(19) United States
(12) Patent Application Publication
(10) Pub. No.: US 2024/0196110 A1
(43) Pub. Date: Jun. 13, 2024

(54) CMOS IMAGE SENSOR FOR RTS NOISE REDUCTION USING NON-LINEAR STATISTICS AND IMPULSIVE METRICS FOR SIGNAL PROCESSING

(71) Applicant: DV2JS INNOVATION LLP., New Delhi (IN)

(72) Inventors: Mukul Sarkar, New Delhi (IN); Tusha Tanya, New Delhi (IN); Abhinav Bhattacharya, New Delhi (IN)

(21) Appl. No.: 18/530,802

(22) Filed: Dec. 6, 2023

(30) Foreign Application Priority Data
Dec. 9, 2022 (IN) 202211071085

(51) Int. Cl. H04N 25/616; H04N 25/77; H04N 25/78

(52) U.S. Cl. CPC H04N 25/616; H04N 25/77; H04N 25/78

(57) ABSTRACT

The invention relates to a CIS technology that uses impulsive metrics and non-linear/higher order statistics to substantially reduce the random telegraph signal (RTS) noise. The CMOS image sensor includes a 4T active pixel pinned photodiode (301), a row select transistor (202), a low noise column level amplifier (203), a thermal noise filter (204), a maxima detector (205) and a minima detector (206), a simple and hold reset switch (207), a simple and hold signal switch (208), an analog to digital convertor (209). The maxima and the minima values obtained from the maxima detector (205) and the minima detector (206) provides a median value. Further, the dual capacitor used in the maxima detector (205) and minima detector (206) gets charged and discharged simultaneously during the reset phase and the signal phase. Due to this, there is a substantial reduction of the RTS noise components.

### FIELD OF THE INVENTION

The present invention relates to a CMOS image sensor that uses non-linear statistics and impulsive metrics for signal processing for RTS noise reduction. More specifically, the RTS noise reduction is achieved by sensing of impulsive metrics to obtain median value or higher order statistics of the input sequence, and specifically targeting RTS noise reduction to enhance and improve image quality.

### BACKGROUND OF THE INVENTION

Digital photography has advanced in leaps and bounds, incorporating features of advanced cameras in compact photographic devices due to rapid developments in image processing techniques. Despite the technological advancements, photography in low light conditions still poses a challenge to technologists working in this field. Even the available advanced cameras have failed to provide better efficiency and high resolution of picture in low-light conditions.

Availability of light is a fundamental requirement for any digital camera, to process a captured image and render a high-resolution image as an output. This is the very reason why photography in low-light conditions renders an image of inferior quality. Obtaining a high-resolution image in low-light conditions is very important when it comes to applications, inter alia, in medical equipment and warfare equipment. For instance, low-light imaging finds a necessary use in endoscopic capsule, fluorescence microscopy, astrophotography, night-vision optics and other surveillance applications.

There are image sensors available which have tried to attend the problems of low light photography. However, the images rendered are of an inferior resolution and are normally laden with noise signals. Further, few of these signal noises have non-Gaussian characteristics. One of the prominent types of the non-Gaussian signal noise present in digital photography is Random Telegraph Signal (RTS) noise. Generally, the random telegraph signal (RTS) noise seen at the pixel output is caused by the presence of a single trap level interacting with the channel charge carriers. The characterized signal in RTS noise is one in which the distribution of noise is random, haphazard and discrete fluctuations between two or more metastable states, and distributed as multiple Gaussian sub-populations. Alternatively, this implies that non-Gaussian signal noises are distributed unequally and non-uniformly with respect to time over the entire length of the signal thereby making the quality of signal poor. Further, such signal noises are characterized as random fluctuations of a continuous-time discrete-amplitude signal, and has a severe impact on the performance of modern CMOS image sensor due to aggressively flashing pixels.

RTS noise is among one of the types of non-Gaussian signal noise wherein the variation of noise with respect to time is distributed non-uniformly and is in a haphazard manner. These signal noises severely affect the quality of image by producing twinkling effect in the image thereby making the image flash. Further, the cause of RTS noise in conventional CMOS image sensor is that there is a significant charge transfer time to avoid non-idealities of the transfer gate in the 4T active pixel photodiode. Primarily, conventional CMOS image sensor is only able to detect signal noises which are of Gaussian type. The Gaussian signal noises have the characteristics in which signal noise is uniformly distributed

Another major problem present with the RTS noise is that its distribution with respect to time is in the order of nano-second. Conventionally, in the CMOS image sensor, to avoid Transfer Gate (TG) non-idealities in a 4T-pixel, a significant amount of time is required for transferring signal charges from the Pinned Photodiode (PPD) to the floating diffusion (FD) node. This leads to limited effectiveness of the Correlated Double Sampling (CDS), especially for small time constant Random Telegraph Signal (RTS) processes. Further, the RTS noise has a time-constants which are of the nanosecond order are completely uncorrelated between the reset and signal phase sampling in CDS.

Further, another problem associated with the RTS noise is that it does not reduces drastically and is most difficult noise to reduce by any image sensor/s. This is one of the most difficult signal noises to capture and reduce drastically because it is of non-Gaussian type. Hence, conventional CMOS image sensor performance is always limited by the presence of RTS noise.

Conventionally, the correlated multiple sampling method is used wherein a CMOS image sensor comprising a circuit capable of calculating the average of M successive samples of an output signal of a pixel of the sensor is used. Correlated multiple sampling circuit is unable to fully eliminate the RTS noise. The RTS noise is primarily generated in the in-pixel source follower transistor in a CMOS image sensor. The RTS noise has a Lorentzian spectrum i.e. it is one of the form of 1/f power spectrum. The noise signal is caused by the presence of a single trap level interacting with the channel charge carriers. Further, various linear statistics are also used to decrease the RTS noise in CIS technology, but they do not drastically decrease the RTS noise in the CMOS image sensors and hence does not produce good quality of image especially in low light environments.

The available CMOS image sensors which reduce RTS noise and non-Gaussian noise are as follows:

U.S. Pat. No. 9,497,400B2 discloses a CMOS image sensor for non-Gaussian noise reduction comprising one pixel and one circuit arranged to receive, on a first node of the circuit, an analog signal representative of the luminosity level received by the pixel, the circuit being capable of successively acquiring 2ⁿ samples of said signal, n being an integer greater than or equal to 2, and of delivering, on a second node of the circuit, an analog signal having a value equal to the average of the values of said samples, without generating an intermediate signal having a value greater than the value of the largest acquired sample, the circuit comprising:
first and second capacitors, the second capacitor having a first electrode connected to the first node via a first switch, and a second electrode connected to a node of application of a reference potential, and the first capacitor having a first electrode connected to the second node and connected to the first electrode of the second capacitor via a second switch, and a second electrode connected to a node of application of the reference potential;
n−1 branches, each comprising two switches in series between the first electrode of the second capacitor and the first electrode of the first capacitor, and a capacitor connecting the junction point of the two switches of the branch and a node of application of the reference potential; and
a control unit capable of controlling the switches to successively acquire 2ⁿ samples of the voltage at the first node in the n+1 capacitors, and of delivering, across the second capacitor, a voltage equal to the average of the acquired samples.

U.S. Ser. No. 10/594,967 discloses a sample-and-hold circuit which includes an amplifier transistor, a resistor connected between a source terminal of the amplifier and a predetermined voltage, a first switch connected in parallel with the resistor, and a second switch connected between a gate terminal of the amplifier transistor and the predetermined voltage.

Further, US'967 discloses an image sensor that includes a pixel circuit configured to convert incident light into an analog signal; and a sample-and-hold circuit configured to receive the analog signal, wherein the sample-and-hold circuit includes an amplifier transistor, a resistor connected between a source terminal of the amplifier and a predetermined voltage, a first switch connected in parallel with the resistor, and a second switch connected between a gate terminal of the amplifier transistor and the predetermined voltage.

In furtherance of this, US'967 also discloses a technique of periodic switching wherein when the first switch is closed and the second switch is open, the amplifier transistor is in an inversion mode; and when the first switch is open and the second switch is closed, the amplifier transistor is in an accumulation mode. So, the noise is reduced using the amplifier transistor.

U.S. Pat. No. 9,380,234 discloses a reduced random telegraph signal (RTS)-noise CMOS image sensor wherein the image sensor includes a pixel and a correlated double sampling (CDS) circuit electrically connected to the pixel. The CDS circuit is characterized by a CDS period that includes a reference sample period and an image data sample period. The image sensor also includes a bit line, a bitline connection switch between the pixel and a readout circuit connected to the pixel, and a bitline switch controller. The bitline transmits a transfer gate signal as a bitline signal having a non-zero value during a first time period entirely between the reference sample period and the image data sample period. The bitline switch controller is electrically connected to and configured to control the bitline connection switch such that the bitline connection switch is closed during the entire CDS period except for a single continuous open period that includes the first time period.

U.S. Pat. No. 8,513,102 discloses an active silicon MOS field effect device, defined on a substrate having a width dimension equal to or less than 350 nm and a length dimension equal to or less than 350 nm, has a conduction channel behind the gate electrode doped to an ionized dopant atom concentration in the range of between 10¹³ to 10¹⁵ atoms per cubic centimetre to reduce the random telegraph signal (RTS) and 1/f noise in the device. Further, US'102 discloses a nanoscale scale, or less than a 1000 nm scale, size effects can become important in determining the RTS or 1/f noise of CMOS transistors. The nanoscale is the size at which the expected fluctuations of the averaged properties due to location of individual particles cannot be reduced to below some desirable threshold of a few percent. For dimensions less than 1000 nm, or atomic dimensions of 1000 Å, the locations of individual atoms and electronic charges become important and result in an apparent amplification of random telegraph signal, RTS, noise in nanoscale transistors currently being used in MOS and CMOS memory, logic, and imaging devices.

Further, US'102 discloses usage of a planar NMOS transistor that may be in CMOS configuration is fabricated on a substrate with very low doping of 10¹⁵ atoms per cubic centimetre resulting in a very low concentration of ionized acceptor impurity atoms. A range of values from 10¹³ to 10¹⁵ atoms per cubic centimetre is preferred. The transistor has conventional source, drain, and gate structures. The effective substrate doping can be made even lower by counter doping with donor type impurities. The low substrate, or low effective substrate, doping results in few potential peaks in the channel and fewer percolation channels and consequently lower RTS noise.

Thus, conventional method of reducing RTS noise require substantial changes in the structure of the photodiode. Due to this reason, process of reducing RTS noise components is quite expensive. Further, due to structural changes in CMOS image sensor, there is an increase in number of components which impacts overall size and operational requirements of the CMOS image sensor.

Therefore, conventional method is yet not enough to substantially reduce RTS components because RTS noise components is still present in few of pixels of the photodiode and is sufficient enough to hamper quality of the image. The reason is that the source follower transistor causes an occurrence of trapped electrons in holes during operation of an overall voltage gain. Even presence of few RTS noise components in the signal causes a reduction in the image quality. So, drastic reduction of RTS noise is very important to improve the image quality.

Further, the RTS noise components has a time-constant of the order of nano-second and conventional method still requires significant charge transfer time which thereby causes few pixels to have RTS noise components.

Thereby, there is requirement of a CMOS image sensor wherein the time constant is of order of nano-second to eliminate random telegraph signal (RTS) noise substantially to improve quality of the image. Another requirement is to provide a CMOS image sensor which do not substantially changes the architecture of the CMOS image sensor and specifically the composition of active area and the pixel overall is not changed.

So, it is an object of the present invention to overcome the problems present in the prior art and provide an improved CMOS image sensor which provide better quality of image by drastically reducing RTS noise. Thus, the present invention provides a CMOS image sensor which uses non-linear statistics and impulsive metrics for signal processing for carrying out drastic RTS noise reduction.

### SUMMARY OF THE INVENTION

There is a need for a more effective, competent, efficient, compact, economical, and a high dynamic range CMOS image sensor, which uses a novel analog signal processing method based on correlated impulsive metrics like maxima, minima, median value of the RTS noise and higher order statistics for multiple sampling to decrease RTS noise.

The present invention relates to a CMOS image sensor that uses non-linear statistics and impulsive metrics for signal processing for RTS noise reduction. The RTS noise reduction is achieved by sensing of impulsive metrics to obtain median value or higher order statistics of the input sequence, specifically targeting RTS noise to enhance and improve the image quality.

The RTS noise reduction CMOS image sensor comprises of a plurality of 4T active pixel photodiode, wherein the 4T active pixel photodiode includes:
a plurality of a pinned photodiode (PPD), wherein the pinned photodiode is configured to generate and accumulate photo electrons when light of pre-determined wavelength is incident on them;
a plurality of a transfer gate (TG), wherein the transfer gate is configured to transfer the photo generated electrons from the PPD to the floating diffusion node (305) and store them for pre-determined duration;
a plurality of a reset transistor (MRST), wherein the MRST reset the floating diffusion node to eliminate residual signal from floating diffusion node of the PPD;
a plurality of a reset signal switch, wherein the reset signal is configured to operate the MRST in ON/OFF mode;
a plurality of a source follower (SF) transistor, wherein the source follower converts the charges stored on the floating diffusion node to a voltage with a pre-determined voltage gain;
a plurality of a row selection (RS) transistor, wherein the row selection is configured to read each row present in PPD; and a plurality of column current source in between the row selection transistor and a column level readout circuit, wherein the column current source is grounded.

Further, the column level readout circuit comprises of:
a plurality of low-level noise column level amplifier (CLA), wherein the CLA is configured to provide sufficient gain to signal received from source follower for suppressing noise;
a plurality of thermal noise filter, wherein the thermal noise filter is configured to filter out thermal noise components from RTS noise components;
a plurality of maxima detector and minima detector, wherein the maxima detector and minima detector are configured to provide maxima value and minima value to input signal provided by thermal noise filter;
a plurality of sample and hold reset (SHR) switch, wherein the SHR switch is configured to hold obtained median value provided by the maxima and minima detectors respectively;
a plurality of sample and hold signal (SHS) switch, wherein the SHS switch is configured to hold signal obtained through median value provided by the maxima and minima detectors respectively;
a plurality of analog to digital convertor (ADC), wherein the output from the SHR and SHS switches are provided to positive node and negative node of ADC respectively; and
a means to provide digital number generated by the ADC which is a representative of the voltage level at the input of the ADC.

Further, the present CMOS image sensor is effective, competent, efficient, and has a high dynamic range for RTS noise reduction through sensing impulsive metrics by obtaining median value and/or higher order statistics of input sequence targeting RTS noise to enhance and improve image quality.

The present invention relates to a novel method for RTS noise reduction which is achieved by application of higher order statics in the output of a CMOS image sensor. The method includes:
Initial charging of a capacitor C1 and capacitor C2 to an initial voltage of Vss and Vdd respectively;
Sampling of an input voltage at Vin that is obtained from the output of a thermal noise filter;
Comparing the sampled input voltage Vin with the voltage stored across the capacitor C1 and the capacitor C2 using comparators;
On comparing Vin with Vc1 it is determined that Vin<Vc1. In this case, switch S1 is turned ON and C1 is discharged linearly for a pre-determined time until Vin=Vc1. This operation provides a maximum value of the input sequence and is stored in Vo1;
On comparing Vin with Vc1 it is determined that Vin<Vc2. In this case, switch S3 is turned ON and C2 is charged linearly for a pre-determined time until Vin=Vc2. This operation provides a minimum value of the input sequence and is stored in Vo2;
Values obtained from both the situation i.e. during Vin>Vc1 and Vin<Vc2 is used to settle at (Vo1+Vo2)/2, i.e, the median value by turning on switch S5.
Finally, the median value will enter into the ADC to generate the digital signal which will provide the improved quality of the image by RTS noise reduction.

This summary is not intended to limit the key essential features of the present invention nor its scope and application. Other advantages and details about the system and the method will become more apparent to a person skilled in the art from the below detailed description of the invention when read in conjugation with the drawings.

### BRIEF DESCRIPTION OF THE ACCOMPANYING DRAWINGS

Embodiments are described with reference to the following Figures. The same numbers may be used throughout to reference like features and components that are shown in the Figures:

FIG. 1 (a) illustrates a simulated waveform of RTS noise using a model used in the analysis section.

FIG. 2 illustrates a top-level architectural block diagram for the novel CMOS image sensors in accordance with the present invention.

FIG. 3 illustrates a circuit schematic of a standard 4T active pixel sensor used in the CMOS image sensor in accordance with the present invention.

FIG. 4 illustrates a waveform obtained at the floating diffusion (FD) node.

FIG. 5 illustrates schematic diagram of maxima and minima detector used in the column level readout circuit.

FIG. 6 illustrates a flowchart outlining the novel method used in the operation of median detection circuit.

FIG. 7 illustrates a plot of output noise power (in dB) with increasing operation window (MTₛ) for fast RTS noise (τₛ=1 μs), for both averaging and proposed invention.

FIG. 8 illustrates a plot of output noise power (in dB) with increasing operation window (MTₛ) for relatively slower RTS noise (τₛ=15 μs), for both averaging and proposed invention.

FIG. 9 illustrates a method of reduction of the random telegraph signal (RTS) noise in the reset phase in accordance with the embodiment of the present invention.

FIG. 10 illustrates a method of reduction of the random telegraph signal (RTS) noise in the signal phase in accordance with the embodiment of the present invention.

### DESCRIPTION

The present invention can be understood with reference to the detailed figures and description set forth herein. Various embodiments are discussed below with reference to the figures. However, those skilled in the art will readily appreciate that the detailed descriptions given herein with respect to the figures are simply for explanation of the invention as the methods and systems may extend beyond the described embodiments. For example, the teachings presented and the needs of a particular application yield multiple alternative and suitable approaches to implement the functionality of any detail described herein. Therefore, any approach extends beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, circuit, architecture, characteristic, property, element, or limitation but that not every embodiment or example necessarily includes that particular feature, circuit, architecture, structure, characteristic, property, element, or limitation. Further, repeated use of the phrase “in an embodiment” does not necessarily refer to the same embodiment.

### Terms

Length of the signal is defined as the period of the signal which is analysed for over a pre-determined time duration.

| ABBREVIATION | MEANING |
|---|---|
| CIS | CMOS image sensor |
| CMOS | Complementary metal-oxide semi-conductor |
| CDS | Correlated double sampling |
| PPD | Pinned photodiode |
| M_{RST} | Reset transistor |
| TG | Transfer gate |
| SF | Source follower transistor |
| CLA | Column level amplifier |
| RS | Row select transistor |
| ADC | Analog to digital convertor |
| SHR | Sample and hold reset switch |
| SHS | Sample and hold signal switch |

### DESCRIPTION

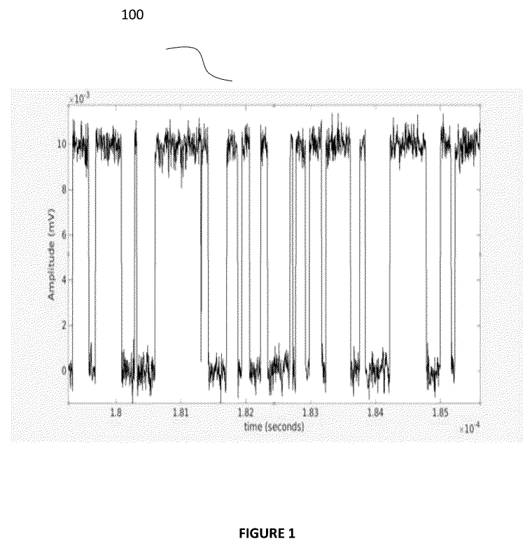

It is well known that in the CMOS image sensor the RTS noise are present. For instance, as shown in FIG. 1 which illustrates a waveform of RTS noise with respect to time constant 100 mili-seconds obtained through a conventional CMOS image sensor. The waveform in a graph illustrates that in the RTS noise there is a discrete amplitude variation with respect to a time-constant. The distribution of RTS noise with respect to different time-constant is non-uniform, uneven and moving in a haphazard manner. These characteristics of the RTS noise makes it difficult to get read, processed and eliminated by a conventional process of determination of average of successive samples of an output signal of a pixel of a sensor in a CDS method and which is used in a conventional CMOS image sensor.

In conventional method of CDS, noise reduction is done through two capacitors of same capacitance which are respectively charged to voltages V1 and V2 and are connected in parallel. Further, the voltage across the parallel association of the two capacitors takes value V1-V2 to provide output signal with reduced Gaussian noise.

In the conventional CDS technique, to avoid non-idealities of the transfer gate, the charge transfer time is increased. Due to this, there is an increase in the time-constant to the order of milli-seconds and on the other hands RTS noise is in the order of time-constant of nano-second. This is the reason because of which conventional CDS technique is unable to reduce significant amount of RTS noise. Hence there is a significant hampering of the quality of the image.

The available CMOS image sensors uses the linear statics for signal processing which will not result into good quality of image.

Thereby, there is an urgent requirement of improvement in the CMOS image sensor where RTS noise is reduced significantly. The same is achieved by the application of higher order statistics in the output of a novel CMOS image sensor. This substantially reduces RTS noise and thereby improves image quality. Thus, present invention provides a CMOS image sensor for RTS noise reduction using non-linear statistics and impulsive metrics for signal processing.

The present CMOS image sensor for drastic reduction of RTS noise uses maxima detector and minima detector to determine maxima value and minima value of the voltage of the signal respectively during a reset phase and a signal phase. These values on summation provides median value or higher order statistics of the voltage of the signal during the reset phase and signal phase. Further, during determination of the maxima and the minima values, a capacitor C1 and a capacitor C2 is used which charges and discharges simultaneously according to a pre-determined condition which thereby allowing sensing of the required higher order statistics. Due to this feature, there is reduction of the time-constant, thereby, it is one of the major solutions which substantially and drastically reduces RTS noises from the signal. This leads to an improvement in the image quality from present CMOS image sensor.

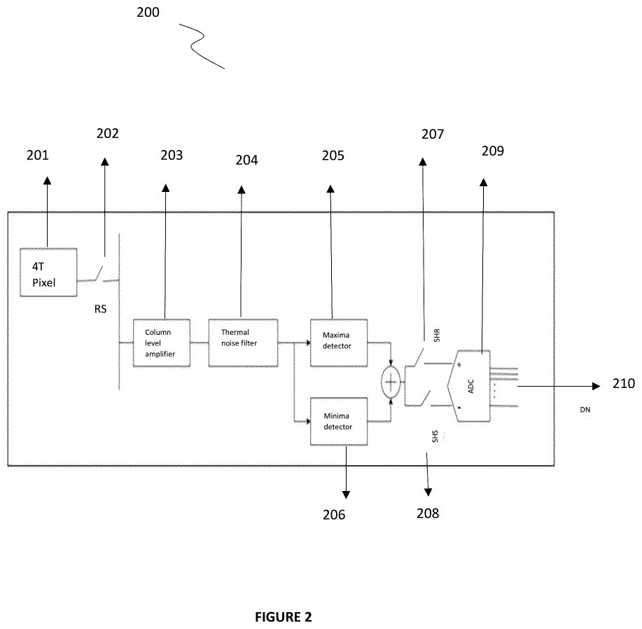

FIG. 2 illustrates a novel circuit architecture for the proposed method which drastically reduces RTS noise from the CMOS image sensor in accordance with the embodiment of the present invention. The circuit (200) comprises of a 4T active pixel photodiode (201), a RS transistor (202), a low noise CLA (203), a thermal noise filter (204), a maxima detector (205), a minima detector (206), a SHR switch (207), a SHS switch (208), an ADC (209) and a digital number (210). The 4T active pixel photodiode (201) is an array of plurality of pixels arranged in a column and in a row present onto the PPD. The pixels on the 4T active pixel photodiode (201) are sensitive to incident light of the visible spectrum. Alternatively, the spectrum/wavelength of light can vary from infrared to visible spectrum. Further, the 4T active pixel photodiode (201) generates and accumulates photo-electrons on being subjected to photons in the form of light. The photodiode in the present invention is a pinned photodiode. Alternatively, the material of the photodiode may vary as per the convenience of the user. The pinned photodiode has reduced dark current in the image thereby improving its quality.

Prior to exposure of light onto the 4T active pixel photodiode (201), the novel circuit in the present invention operates in a reset phase. This reset phase operation ensures elimination of residual signal from the sense node of the photodiode of the CMOS image sensor otherwise it will interfere in the RTS noise components and will severely hamper the quality of the image. During the reset phase, M_RST (306) is switched ON present in the 4T active pixel photodiode (201). The output from the 4T active pixel photodiode (201) is feed as an input to the M_SF transistor (308). The 4T active pixel photodiode (201) signal is read out using RS transistor (202) in each row of the pixels. Further, the RS (202) transistor connected with the node of low noise CLA (203). The functionality of low noise CLA (203) is to provide a sufficient gain to suppress the noise contribution of the column level circuits, making sure that the overall noise at output is dominated only by the in-pixel components. The CLA (203) output passes through the thermal noise filter (204). The thermal noise filter (204) ensures that the thermal noise components are filtered out from the RTS noise components. This will further ensure that the impulse metrics calculated in the subsequent stage corresponds only to the RTS component of noise. Further, in the circuit there are two types of detectors which are used i.e. maxima detector (205) and minima detector (206). These detectors (205 and 206) determine maxima value and minima value of the input sequence. The maxima and minima values are summed up to provide median value of the input sequence. Further, the median value is sampled at the positive node of the ADC (209) by switching ON the sample and hold reset (SHR) switch (207). The digital number (210) generated by the ADC is the representative of the signal voltage integrated in the pixel.

The same chain of circuit is used during a signal phase wherein light is incident onto the 4T active pixel photodiode (201) i.e. onto the pinned photodiode for a pre-determined time duration. During the signal phase, same chain is followed except that maxima and minima values that is used for determination of median value of the input sequence is applied to the ADC (209) through the SHS switch (208).

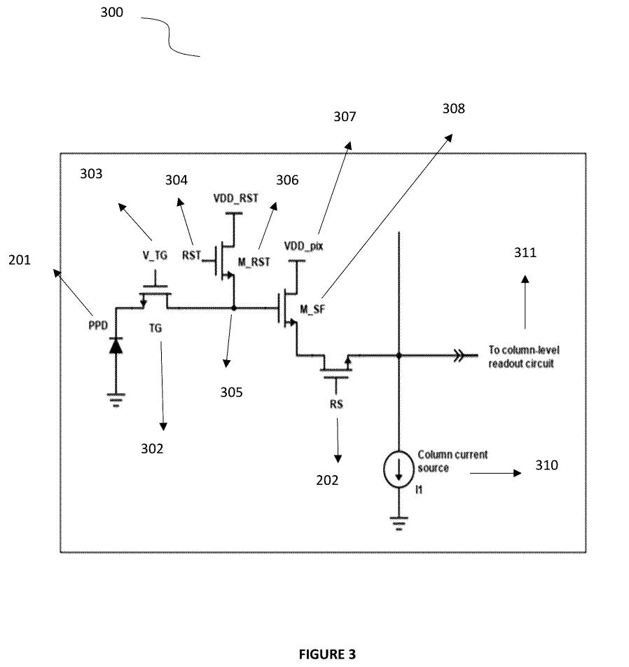

FIG. 3 illustrates circuit schematic arrangement of a standard 4T active pixel photodiode (300) used in the CMOS image sensor in accordance with the embodiment of the present invention. The 4T active pixel photodiode (300) includes a plurality of a PPD (201), a plurality of a TG (302), a plurality of a MRST (306), a plurality of a reset transistor switch (304), a plurality of a SF transistor (308), a plurality of a RS transistor (202) which is further connected with the column level readout circuit (311). In between the node of column level circuit (311) and the RS transistor (202), there is a node of plurality of a column current source I1 (310) which is grounded. The column level readout circuit (311) includes low noise CLA (203), thermal noise filter (204), maxima and minima detectors (205, 206), SHR switch (207), SHS switch (208), ADC (209) which generates a digital number (210) which is a representative of the voltage of digital sequence.

Prior to exposure of photons in the form of light on the pinned photodiode (201) i.e. during the reset phase the reset transistor MRST (306) is switched ON by applying a high RST (304) signal. Due to this, there is a drop of voltage to the level of reset i.e. VDD_{RST}-Vₓ at the node (305) wherein the Vₓ drop corresponds to the MRST transistor's charge-injection and kTC noise. The thermal noise and charge injection contributed by the reset switch, is eliminated after the CDS operation. Further, this reduced voltage is input to the SF transistor (308). The supply voltage of the SF transistor is VDD_pix (307). The functionality of the SF transistor (308) is to buffer its input voltage to the output. Instead of SF transistor, any amplifier configuration can be also be used to provide an overall voltage gain and buffer the pixel output.

The output obtained from the SF transistor (308) is input to the RS transistor (202). Due to this, each row of pixel is read and information is processed in column during the readout operation.

The output from the RS transistor (202) is input to the node of the column level readout circuit (311). This ensures reading and processing of the photodiode (201) information of each of the column of pixels. Thus, the novel circuit ensures reading and processing of each column and row of pixels present. In other words, during the signal phase, residual signal present into PPD (201) is read and processed properly which ultimately strengthens quality of the image. The column current source I1 (310) present between the RS transistor (202) and column level readout circuit (311) enables storage of the information of signal obtained from each column and row of the pixels in the low noise CLA. Further, the column current source I1 (310) ensures required biasing of the SF transistor (308) during operation of the read-out chain

The functionality of the low noise CLA ([203] as shown in FIG. 2) present in the column level readout circuit (311) is to allow a sufficient gain to suppress the noise contribution of the column level circuits, making sure that the overall noise at output is dominated only by the noise of the pixel. This amplified signal from output of the low noise CLA (203) is feed to the thermal noise filter (204). The functionality of the thermal noise filter (204) is to reduce thermal noises leaving only the RTS noise components in the input sequence/signal.

In furtherance of this, the output from the thermal noise filter (204) is fed to the maxima detector (205) and the minima detector (206) to determine maxima value and minima value of the signal. These values are summed up in order to obtain/determine median value of input sequence/signal. The median value is fed to the ADC (209) through closing the SHR (207) and SHS switch (208). The output from the ADC (209) generates a digital number (210) which represent the signal voltage integrated in the pixel.

When photons in the form of light falls onto the pined photodiode (201), for a pre-determined time duration, there is a generation and accumulation of photo-electrons. Further, this form of incident light falls into the category of visible spectrum. In an exemplary embodiment, an electromagnetic radiation may be light, from the range of infrared to visible light. Further, the PPD (201) is an p+/n-well/p-sub type. Alternatively, the material of the pinned photodiode may vary. The floating diffusion (FD) node (305) is initially reset by turning on the reset transistor M_RST (306). The reset potential of the FD node is determined by VDD_RST. The accumulated charges in the photodiode are transferred to the FD node (305) after a pre-determined time-duration. The charges are transferred from the photodiode to the FD node by closing the TG (302) switch. The gate signal applied to turn ON the TG transistor is V_TG (303). The stored charges on the FD node are converted to a voltage using a SF transistor (308). It is pertinent to note that, when the charges are transferred from the photodiode to the FD node, there is a drop in the output of the SF transistor (308) from Vx to Vsig. The output from the SF transistor (308) is available in the column when RS transistor (202) in ON. The information in the column is fed onto the column level readout circuit. Further, through the column level readout circuit (311), the output is fed onto the low noise CLA (203). The output from the low noise CLA (203) is fed onto the thermal noise filter (204). The filtered signal from the thermal noise filter (204) is feed into maxima detector (205) and minima detector (206) to obtain/determine median value by summing up the maxima and the minima values. The median value obtained for the signal is feed onto the ADC (209) by turning the SHS (208) switch ON. The analog to digital convertor generates a digital number (210) which is representative of voltage of the digital signal.

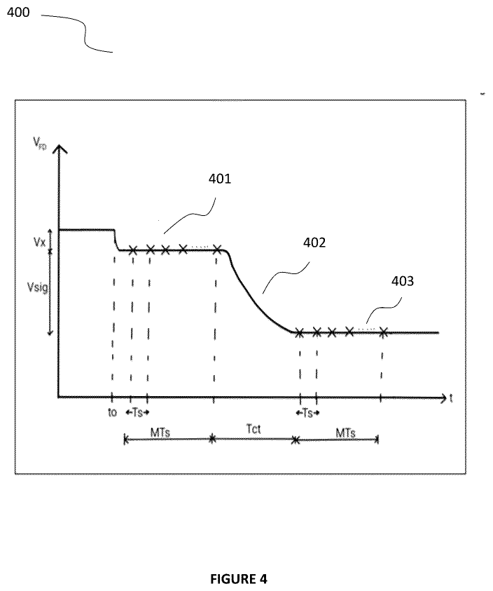

FIG. 4 illustrates a waveform obtained at the floating diffusion (FD) node of the 4T-active pixel sensor (APS) during reset phase (401), charge transfer phase (402), and the signal phase (403) is shown. M is the record length for both reset and signal phase, with sampling period Tₛ. T_{ct} is the charge transfer time. In the present invention, there is a transition of at least a phase between the reset phase (401) and the signal phase (403) to cancel and eliminate the RTS noises from the input sequence to improve quality of the image. Vx corresponds to the voltage which is acquired during the reset phase (401) and Vsig (403) corresponds to the voltage which is acquired during the signal phase. In between the reset phase (401) and signal phase (403), there is a transition of the charge transfer phase (402). This charge transfer phase (402) occurs after the pinned photodiode (301) has integrated the incident photons in the form of light. Due to this incident light, there is generation and accumulation of photons which is further transferred and stored at the floating diffusion node (305).

There is a difference between the voltage Vx generated during the reset phase (401) and voltage Vsig generated during the signal phase (403). This voltage difference corresponds to the amount of photons integrated in the photodiode. The multiple sampling of the reset phase and the signal phase and its suitable processing in the column helps in substantial elimination of other signal noises including the RTS noise components which ultimately improves and strengthen the quality of the image obtained through CMOS image sensor.

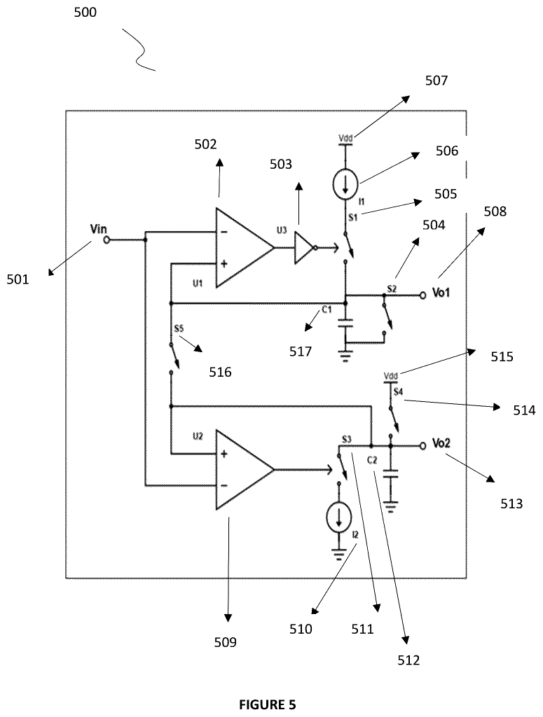

FIG. 5 illustrates a simplified schematic of the maxima detector and the minima detector used in the column level readout circuit which has an input voltage Vin (501), a plurality of a first comparator U1 (502), plurality of inverter buffers U3 (503), a first switch S1 (505), plurality of a current source I1 (506), a plurality of a second comparator U2 (509), a plurality of current source I1 (506), a plurality of a current source I2 (510), a plurality of a first capacitor C1 (517), a plurality of a second capacitor C2 (512), a second switch S2 (504), a third switch S3 (511) a fourth switch S4 (514), a fifth switch S5 (516), a first voltage V₀₁ (508) and a second voltage V₀₂ (513). In the illustrated FIG. 5, there are five switches used and alternatively, the number of switches used in the maxima and the minima detector may vary.

The first comparator U1 (502), the inverter buffer U3 (503), switch S1 (505), the current source I1 (506), and capacitor C1 (517) together constitute the maxima detector. The combination of the inverter buffer U3 (503) and switch S1 (505) acts as an active low switch which turns ON only when the first comparator output U1 (502) is high. The second comparator U2 (509), switch S3 (511), current source I2 (510) and capacitor C2 (512) together constitute the minima detector. Further, in present CMOS image sensor, U1 (502) and U2 (509) are two comparators. U1 (502) is the part of the maxima detector and U2 (509) the part of minima detector. The maxima and minima detector are two path the signal takes from the thermal noise filter.

In this circuit, the sampled input voltage Vin (501) is fed to the first comparator U1 (502) and the second comparator U2 (509) of the maxima and the minima detector respectively. In the maxima detector, the output of the first comparator U1 (502) is fed to the active low switch composed of U3 (503) and S1 (505). The active low switch connects the current source I1 (506) to the first capacitor C1 (517). Further, the first capacitor C1 (517) is connected to the fifth switch S5 (516) and the first output voltage Vₒ₁ (508). The capacitor C1 (517) is initially charged and reset to 0 V using switch S2 (504). This allows the capacitor to be devoid of charges thus ensuring that it is empty.

In the minima detector, the output of the second comparator U2 (509) controls the third switch S3 (511) to discharge the capacitor C2 (512) through the current source I2 (510). Further, the second capacitor C2 (512) is connected to the fifth switch S5 (516) and the second output voltage Vo2 (513). The capacitor C2 (512) is initially charged and set to voltage VDD using switch S4 (514). This ensures that the capacitor C2 (512) has charges stored into it.

The input voltage Vin (501) is processed at the negative terminal of the first comparator U1 (502) and to the negative terminal of the second comparator U2 (509). The feedback delivered from output of the first comparator U1 (502) sense the error signal. Further, if the error signal is positive, the output will go high and the capacitor C1 will be connected to current source I1 (506) through switch S1 (505). I1 charges the capacitor C1 (517) to a higher potential. As the difference between the comparator inputs eventually approaches 0 V i.e. Vin=V_C1, the comparator output goes low disconnecting the current source I1 (506) and the output first voltage Vo1 (508) settles at the maxima of the input sequence. e

The opposite approach is used in the minima detector. The second voltage Vo2 (513) node is reset to VDD using the fourth switch S4 (514), and an NMOS current source I2 (510) is enabled by the comparator using the third switch S3 (511) to discharge capacitor C2, until the error becomes zero. The second capacitor C2 (512) therefore keeps discharging until the minima of the input sequence at Vo2 is obtained i.e till Vin=V_C2. Since the capacitor C2 (512) has charges stored in it discharging of the capacitor is possible. On closing the switch S5 (516) switch forces both Vo1 and Vo2 voltages to settle at (Vo1+Vo2)/2, i.e, the median value

The mathematical equivalent of the mentioned operation is as follows:

Vₒᵤₜ=A×[max(V_{R})+min(V_{R})−max(V_{S})−min(Vₛ)]

Where A is the overall gain of the system, V_{R} and V_{S} are the input voltage sequences/vectors during the reset phase and signal phase respectively.

In furtherance of this, in the circuit when the first capacitor C1 and the second capacitor C2 is connected in parallel then the total capacitance of a set of parallel capacitors is simply the sum of the capacitance values of the individual capacitors. Hence, when the switch S5 (516) is ON, the resultant voltage as received is (Vo1+Vo2)/2, i.e, the median value.

In the present invention, the simultaneous charging and discharging of the first capacitor C1 (517) and the second capacitor C2 (512) allows sensing of the higher order statistics and thereby the novel circuit of the CMOS image sensor allows substantial reduction of RTS noise from the CMOS image sensor and thereby improving quality of the image.

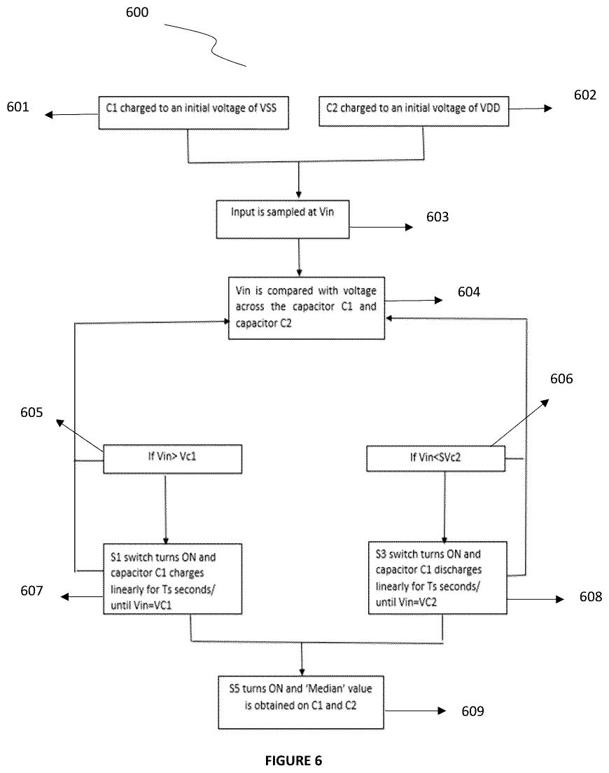

FIG. 6 illustrates a flowchart outlining the method used in the operation of the median detection circuit (600) in accordance with the embodiment of the present invention. In the first step (601) the capacitor C1 is initially reset to 0 V such that capacitor C1 is devoid of charges. Thereafter, at step 602, the capacitor C2 is initially charged and set to voltage VDD and then at step 603, the input voltage Vin is sampled on the input of the first comparator (U1) and the second comparator (U2). Further, at step 604, first comparator (U1) compares the sampled voltage Vin with the voltage across the capacitor C1 and capacitor C2.

On comparing Vᵢₙ and V_{c1}, if Vᵢₙ>V_{c1}, the circuit follows the next step 605, wherein according to the condition as mentioned in the step (607), switch S1 is turn ON and the capacitor C1 is charged linearly for a pre-determined time duration until Vᵢₙ=V_C1. This provides maxima values from the input sequence and is stored at Vo1.

On comparing Vᵢₙ and V_{c2}, if Vᵢₙ<V_{c2}, the circuit follows the next step (606), wherein according to the condition as mentioned in the step 608, switch S3 is turn ON and the capacitor C2 is discharged linearly for a pre-determined time duration until Vᵢₙ=V_{c2}. This provides minima values from the input sequence and is stored at Vo2.

Then at final step (609), the switch S5 is turn ON and median value is obtained by summing up the maxima and the minima values and is obtained on capacitor C1 and capacitor C2 respectively.

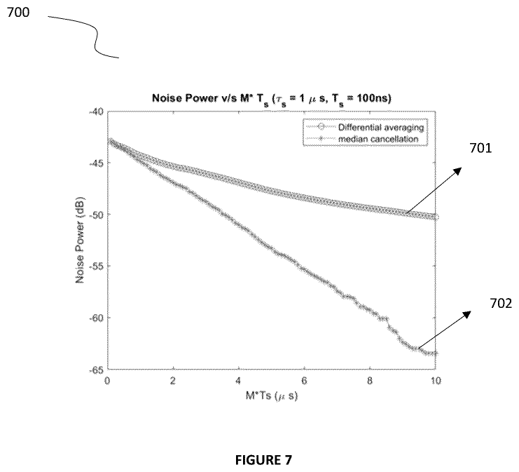

FIG. 7 illustrates a plot (700) of output noise power (in dB) with increasing operation window (MTₛ) for fast RTS noise (τₛ=1 μs), for both averaging (701) and proposed median cancellation (702) technique. In this graph the output of noise power is extrapolated wherein at the time-constant of one micro-second there is a substantial reduction of RTS noise by median cancellation (702) technique as represented by the inclined horizontal line. This when compared with the CDS method (701), the slope of the horizontal line is smaller compared to the slope formed by median cancellation (702) technique. This implies the presence of RTS noise in the CMOS image sensor hence the RTS noise is not fully eliminated.

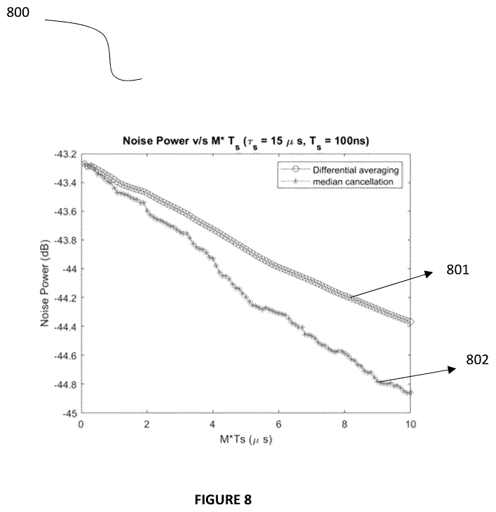

FIG. 8 illustrates a plot (800) of output noise power (in dB) with increasing operation window (MTₛ) for relatively slower RTS noise (τₛ=15 μs), for both averaging (801) and proposed median cancellation (802) technique. In this graph the output of noise power is extrapolated wherein at the time-constant of 1 micro-second there is a substantial reduction of RTS noise by median cancellation (802) technique as represented by the inclined horizontal line. This when compared with the CDS method (801), the slope of the horizontal line is smaller compared to the slope formed by median cancellation (802) technique. This implies the presence of RTS noise in the CMOS image sensor hence, the RTS noise is not fully eliminated.

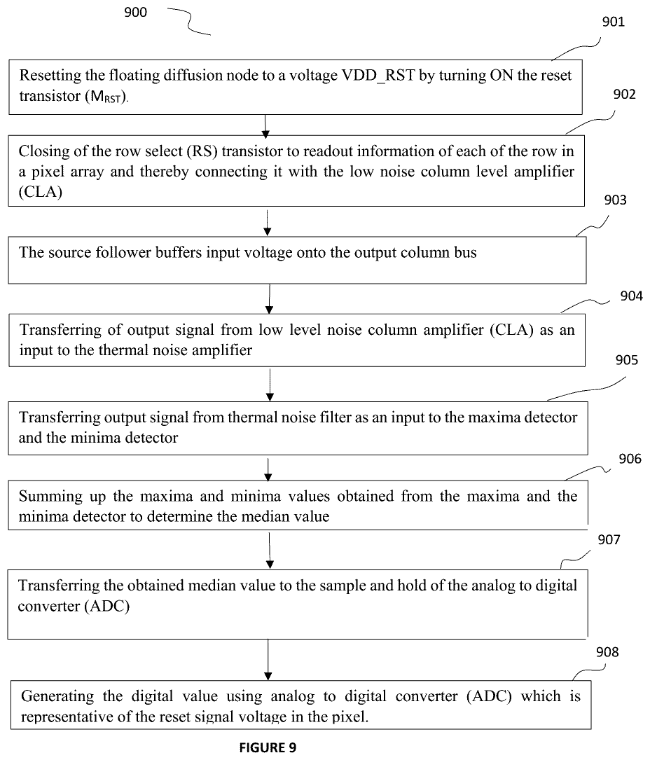

FIG. 9 relates to the method of reduction of the random telegraph signal (RTS) noise in the reset phase (900) through using the novel circuit. The method includes:
at first step (901), the MRST is turned ON by applying reset switch which reset the floating diffusion node a voltage VDD_RST. This step ensures that in the CMOS image sensor, residual signal is not present otherwise these residual signal noises will interfere with the quality of the image;
Further at step (902), the RS transistor (202) is closed to readout information of each row in a pixel array and thereby connecting it with the column level readout circuit. The RS transistor connects the pixel with the column bus for the pixel output to be read by the low noise column level amplifier CLA present in the column level readout circuit. The low noise CLA functionality is to provide a sufficient gain to suppress the noise contribution of the column level circuits, making sure that the overall noise at the output is dominated only by the in-pixel components. Thereby, RS transistor and column level readout circuit is used to read and process information present at each row and column of pixel present;
Then at step (903), the SF transistor (308) buffers its input voltage onto the output column bus;
Then at next step (904), the output signal is transferred from low level noise column amplifier CLA as an input to the thermal noise filter. The thermal noise filter eliminates thermal noise components from the input signal thereby strengthening quality of the image;
Thereafter at step (905), the output signal is transferred from thermal noise filter (204) as an input to the maxima detector (205) and the minima detector (206);
Subsequently at step (906), the maxima and minima values obtained from the maxima detector (205) and the minima detector (206) are summed up to determine median value;
Eventually at step (907), the obtained median value sampled onto the sample and hold using SHR switch (207) of the ADC;
Then at last step (908), digital number is generated using ADC (209) which is a representative of reset voltage integrated in the pixel.

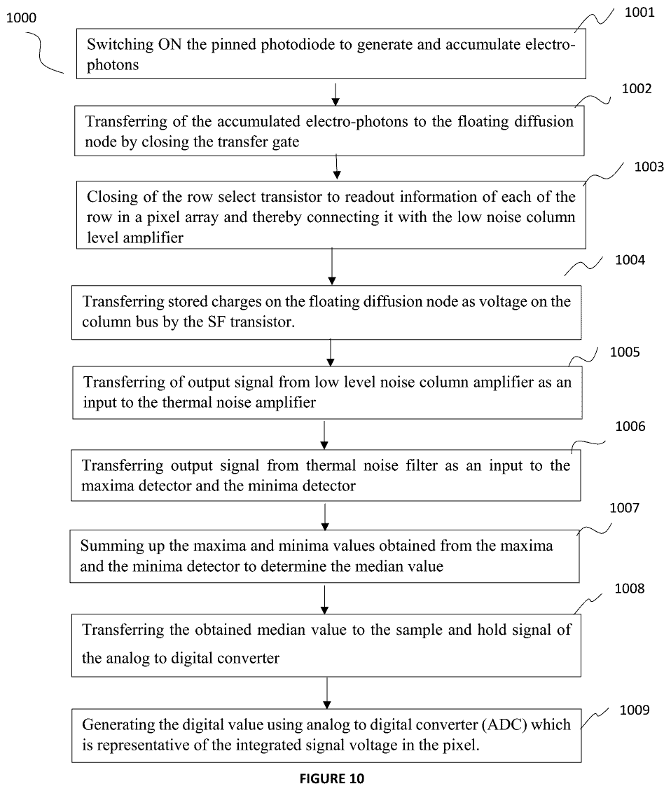

FIG. 10 relates to the method of reduction of the random telegraph signal (RTS) noise in the signal phase (1000) through using the novel circuit of the CMOS image sensor. The method includes:
At step (1001), switching ON the pinned photodiode (201) to generate and accumulate charges generated due to incident photons;
Then at step (1002), transferring and storing of the accumulated electrons to the floating diffusion node (30) by closing the transfer gate (302);
.
Then at step (1003), closing of the RS transistor (202) to readout information of each row in a pixel array and thereby connecting it with the low noise CLA present in the column level readout circuit;
Further, at step (1004), transferring stored charges stored on the floating diffusion node to column bus using source follower transistor (308). Due to this, charges are converted into a voltage Vx by the SF transistor (308) and buffering it to the column bus;
Thereafter at step (1005), transferring output signal from low level noise CLA as an input to the thermal noise filter;
Subsequently at step (1006), transferring output signal from thermal noise filter as an input to the maxima detector and the minima detector;
Then step (1007), summing up the maxima and minima values obtained from the maxima and the minima detector to obtain the median value;
As a result, at step (1008), transferring the obtained median value to the sample and hold of the ADC (209) when SHS switch (208) is ON;
Finally, at step (1009), digital number is generated using ADC (209) which is a representative of the signal voltage integrated in the pixel.

Thus, novel CMOS image sensor uses a novel circuit wherein the higher order statistics is applied which is the median value obtained from maxima and minima values from the maxima detector and the minima detector to provide a good quality of image by drastic reduction of RTS noise.

Further, the maxima detector and the minima detector have dual capacitor which charges and discharges simultaneously. This is important because RTS noise has a time-constant of the order of nano-second. Further, the CMOS image sensor also allows variation of the signal noise over the pre-determined time-constant in a uniform and even manner thus improving the quality of the image.

As a result of above, the novel CMOS image sensor using the unique methodology will
(1) improve the low noise performance of CIS, specifically targeting RTS noise,
(2) use of order statistics instead of linear statistics for RTS noise correction and
(3) performance benefits of the proposed circuit compared to existing circuit.

In another embodiment of the invention, an image processor which is linked to the CMOS sensor 200, determines corresponding intensities of each raw color component of light by measuring the amount of accumulated charge in the plurality of pixels. Also, a memory is present which is communicatively connected to the processor and stores processor instructions. The memory on execution, causes the processor to receive light for a predetermined duration on a pixel array.

In an embodiment, the processor includes suitable logic, circuitry, interfaces, and/or code that are configured to execute a set of instructions stored in the memory. The processor is configured to be implemented based on a number of processor technologies known in the art. Examples of the processor include, but not limited to, image processors or digital signal processors or, an X86-based processor, a Reduced Instruction Set Computing (RISC) processor, an Application-Specific Integrated Circuit (ASIC) processor, a Complex Instruction Set Computing (CISC) processor, and/or other processor.

The memory may include suitable logic, circuitry, interfaces, and/or code that are configured to store the set of instructions, which is executed by the processor. The memory is configured to store one or more programs, routines, or scripts that is executed in coordination with the processor. The memory may be implemented based on a Random Access Memory (RAM), a Read-Only Memory (ROM), a Hard Disk Drive (HDD), a storage server, and/or a Secure Digital (SD) card.

The present disclosure may be realized in hardware, or a combination of hardware and software. The present disclosure may be realized in a centralized fashion, in at least one processing system, or in a distributed fashion, where different elements may be spread across several interconnected systems or circuits.

Further, any of the methods described herein may be totally or partially performed using a digital camera, including one or more processors, which is configured to perform the steps described herein above. Thus, embodiments are directed towards a digital camera including specific components to perform specific steps of any of the methods described herein above. Additionally, any of the steps of any of the methods can be performed using specific circuits.

A description of an embodiment with several components in communication with each other does not imply that all such components are required. On the contrary, a variety of optional components are described to illustrate the wide variety of possible embodiments of the invention. The present disclosure may be realized in a centralized fashion, in at least one processing system, or in a distributed fashion, where different elements may be spread across several interconnected systems or circuits connected to the optical system.

A person with ordinary skills in the art will appreciate that the systems, circuit elements, modules, and sub-modules have been illustrated and explained to serve as examples and should not be considered limiting in any manner. It will be further appreciated that the variants of the above disclosed circuit elements, modules, and other features and functions, or alternatives thereof, may be combined to create other different systems or applications.

While the present disclosure has been described with reference to certain embodiments and exemplary embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope.

1. A CMOS image sensor for RTS noise reduction using non-linear statistics and impulsive metrics for signal processing, the CMOS image sensor comprises of:
a plurality of 4T active pixel photodiode (201), wherein the 4T active pixel photodiode (201) includes:
a plurality of a pinned photodiode (PPD) (201), wherein the pinned photodiode (201) is configured to generate and accumulate photo electrons when light of pre-determined wavelength is incident on them;
a plurality of a transfer gate (TG) (302), wherein the transfer gate (302) is configured to transfer the photo generated electrons from the pinned photodiode (301) to the floating diffusion node (305) and store them for pre-determined duration;
a plurality of a reset transistor (MRST) (306), reset the floating diffusion node to eliminate residual signal from floating diffusion node of the pinned photodiode;
a plurality of a reset signal (304), wherein the reset switch (306) is configured to operate the rest transistor in ON/OFF mode;
a plurality of a source follower (SF) transistor (308), wherein the source follower transistor (308) converts the charges stored on the floating diffusion node to a voltage with a pre-determined voltage gain;
a plurality of a row selection (RS) transistor (202), wherein the row select transistor (202) is configured to read each row;
a plurality of column current source (310) in between a row selection transistor (309) and a column level readout circuit (311), wherein the column current source (310) is grounded.

2. The CMOS image sensor as claimed in claim 1, has a pre-determined rows and columns.

3. The CMOS image sensor as claimed in claim 1, wherein the column level readout circuit (311) provides reading and processing of information of each column of pixels.

4. The CMOS image sensor as claimed in claim 1, wherein the column current source (310) ensures biasing of the source follower transistor (308).

5. The CMOS image sensor as claimed in claim 1, wherein the RTS noise components is characterized by non-uniformity, unevenness, and haphazard movement with respect to time.

6. A column level readout circuit (311) as used in a CMOS image sensor for RTS noise reduction comprises:
a plurality of low-level noise column level amplifier (CLA) (203), wherein the low noise CLA (203) is configured to provide sufficient gain to signal received from source follower for suppressing noise;
a plurality of thermal noise filter (204), wherein the thermal noise filter (204) is configured to filter out thermal noise components from RTS noise components;
a plurality of maxima detector (205) and minima detector (206), wherein the maxima detector (205) and minima detector (206) are configured to provide maxima value and minima value to input signal provided by thermal noise filter (204);
a plurality of sample and hold reset (SHR) switch (207), wherein the SHR switch (207) is configured to transfer median value of the reset signal provided by the maxima and minima detectors (205 and 206) respectively;
a plurality of sample and hold signal (SHS) (208), wherein the SHS switch (208) is configured to transfer median value of the pixel integrated signal provided by the maxima and minima detectors (205 and 206) respectively;
a plurality of analog to digital convertor (ADC), wherein the output sampled when the SHR and SHS switches (207 and 208) are ON are provided to the ADC respectively; and
a digital number generated by the ADC (209) which is a representative of voltage level at input of ADC (209).

7. The column level readout circuit as claimed in claim 6, wherein the column level readout circuit (311) provides reading and processing of information of each column of pixels.

8. The column level readout circuit as claimed in claim 6, wherein the low noise CLA (203) provides output whose overall noise component is dominated by in-pixel component.

9. The column level readout circuit as claimed in claim 6, wherein maxima detector (205) and minima detector (206) circuit includes a plurality of comparator (U1) (502), and plurality of inverter buffers U3 (503), plurality of switches (504, 505, 511, 514, and 516), plurality of current source I1 (506), second comparator U2 (509), plurality of current source I2 (510), first capacitor C1 (517), second capacitor C2 (512), first voltage V01 (508) and second voltage V02 (513).

10. The column level readout circuit as claimed in claim 6, wherein the SHR (207) switch operates during reset phase of the CMOS image sensor.

11. The column level readout circuit as claimed in claim 6, wherein the SHS (208) switch operates during signal phase of the CMOS image sensor.

12. A method of reduction of random telegraph signal (RTS) noise in reset phase through using a CMOS image sensor, wherein the method includes:
first, reset transistor (MRST) (306) is turned ON by applying a reset switch (304) which resets the floating diffusion node to a voltage VDD_RST;
then, the row select (RS) transistor (202) is closed to readout information of each row in a pixel array and thereby connecting it with a column level readout circuit (311);
then, a source follower (SF) transistor (308) buffers its input voltage onto an output column bus;
then, an output signal from a low noise level column level amplifier (CLA) (203) is transferred as an input to a thermal noise filter (204);
thereafter, output signal is transferred from thermal noise filter (204) as an input to maxima detector (205) and minima detector (206);
subsequently, maxima and minima values are obtained from maxima detector (205) and minima detector (206) respectively;
thereafter, the maxima and minima values are summed up to determine a median value;
eventually, obtained median value is transferred to a sample and hold of an ADC (209) when SHR switch (207) is ON; and
lastly, digital number is generated using the ADC (209) which is a representative of reset voltage in the pixel.

13. The method of reduction RTS noise in reset phase through using novel circuit of CMOS image sensor as claimed in 12, wherein switching ON of reset transistor (306) ensures residual signal is eliminated from CMOS image sensor.

14. The method of reduction RTS noise in reset phase through using novel circuit of CMOS image sensor as claimed in 13, wherein switching ON of reset transistor (306) resets the floating diffusion (305) node to VDD_RST.

15. The method of reduction RTS noise in reset phase through using novel circuit of CMOS image sensor as claimed in 12, wherein row select transistor (202) and column level readout circuit (311) provides reading processing information of each row and column of pixel.

16. A method of reduction of the random telegraph signal (RTS) noise in signal phase (1000) through using the novel circuit of the CMOS image sensor. The method includes:
firstly, switching ON a pinned photodiode PPD (201) to generate and accumulate charges generated due to incident photons;
then, transferring and storing of the accumulated electrons to floating diffusion node (305) of by closing a transfer gate (302);
then, closing of a row select transistor (202) to readout information of each row in a pixel array and connecting it to a column low noise amplifier CLA (203);
further, transferring stored charges on the floating diffusion node (305) to the column bus using a source follower transistor (308);
thereafter, transferring output signal from low level noise CLA (203) as an input to a thermal noise filter (204);
subsequently, transferring output signal from the thermal noise filter (204) as an input to a maxima detector (205) and a minima detector (206);
then, summing up maxima and minima values obtained from the maxima detector (205) and the minima detector (206) to obtain median value;
next, transferring the obtained median value to a to a sample and hold of an ADC (209) when SHS switch (208) is ON; and
finally, digital number is generated using the ADC (209) which is a representative of the signal voltage integrated in the pixel.

17. The method of reduction of RTS noise using CMOS image sensor as claimed in 16, wherein the integrated charges are transferred from the photodiode to the floating diffusion node (305) by closing the transfer gate (302) when V_TG is high.

18. The method of reduction of RTS noise using CMOS image sensor as claimed in 16, wherein switching ON row select transistor (202) ensures connecting it with low noise column level amplifier (CLA) (203).

19. The method of reduction of RTS noise using CMOS image sensor as claimed in 16, wherein obtained median value from maxima detector and minima detector switching is sampled on the sample and hold of the ADC by switching ON SHR switch (208).

20. A method of operation of median detection circuit utilized in a CMOS image sensor, wherein the method includes:
firstly, a capacitor C1 is initially charged and reset to 0 V such that a capacitor C1 is devoid of charges;
thereafter, a capacitor C2 is initially charged and set to voltage VDD in order to store charges in the capacitor C2;
then, input voltage Vin is sampled on the input of a first comparator U1 (502) and a second comparator U2 (509);
further, the first comparator U1 (502) compares sampled voltage Vin with voltage across capacitor C1;
on comparing Vin and Vc1, if Vin>Vc1, then a switch S1 is turned ON and the capacitor C1 is charged linearly for a pre-determined time duration until Vin=V_C1;
on comparing Vin and Vc2 if Vin<Vc2, then a switch S3 is turned ON and the capacitor C2 is discharged linearly for a pre-determined time duration until Vin=Vc2; and
lastly, a switch S5 is turned ON and median value is obtained by summing up maxima and minima values obtained on capacitor C1 and capacitor C2 respectively.

21. The method of operation of median detection circuit utilized in CMOS image sensor as claimed in claim 20, wherein providing output from first comparator U1 (502) is used to charge capacitor C1 (517) utilizing switch S1 (505).

22. The method of operation of median detection circuit utilized in CMOS image sensor as claimed in claim 20, wherein the first capacitor C1 (517) is initially charged and reset to 0V using switch S2 (504).

23. The method of operation of median detection circuit utilized in CMOS image sensor as claimed in claim 20, wherein the capacitor C1 is charged linearly for a pre-determined time duration until Vᵢₙ=V_C1 and provides maxima values from an input sequence and is stored at Vo1.

24. The method of operation of median detection circuit utilized in CMOS image sensor as claimed in claim 20, wherein the capacitor C2 is discharged linearly for a pre-determined time duration until Vin=Vc2 and provides minima values from the input sequence and is stored at Vo2.

25. The method of operation of median detection circuit utilized in CMOS image sensor as claimed in claim 20, wherein the median value is obtained from minima value and maxima value.

26. The method of operation of median detection circuit utilized in CMOS image sensor as claimed in claim 25, wherein the median value is obtained by summing up maxima and minima values.
